(19) United States
(12) Patent Application Publication
(10) Pub. No.: US 2014/0330805 A1
(43) Pub. Date: Nov. 6, 2014

(54) RICH CONTENT FOR NO-RESULTS SEARCH PAGE

(71) Applicant: MICROSOFT CORPORATION, Redmond, WA (US)

(72) Inventor: Kun Jing, Beijing (CN)

(73) Assignee: Microsoft Corporation, Redmond, WA (US)

(21) Appl. No.: 13/887,426

(22) Filed: May 6, 2013

(51) Int. Cl. G06F 17/30

(52) U.S. Cl. CPC G06F 17/30864
USPC 707/706

(57) ABSTRACT

Architecture that inserts rich content into a no-results page returned from a search engine query. The rich content can be related to any topic selected (e.g., randomly) for insertion in the no-results page. The topic and content can be obtained from different sources, such as trending topics of social networks, non-profit organization websites, and so on. The content can also include a sharing module that enables the rich content to be shared with other users and/or other media and technologies (e.g., social networks, radio, TV, cell phones, etc.). The architecture can be an application or module of the search engine or a new component that “listens” for the no-results indication as is generated internally to the search engine, and once received, initiates topic selection, content sources access, and retrieval of content for presentation in combination with a no-results notice in a no-results page.

### BACKGROUND

Search engines are essential tools for helping network users to surf the web, for example, and find relevant documents. Though the web index continues to increase as more data is placed online, there is still the likelihood that search engines will not return any results. One study indicates the percentage of the search engine “no result” pages approximates 2-3%, which given the enormity in pages typically processed, is quite large. Typically, search engine “no result” pages are empty of any content other than a small set of words instructing the user to either change the keyword or check the spelling—a time wasting and annoying experience for the user and a lost opportunity for the search engine provider.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture inserts rich content in a no-results page returned from a search engine query. The rich content can be related to any topic selected (e.g., randomly) for insertion in the no-results page. The topic and content can be obtained from different sources, such as trending topics of social networks, non-profit organization websites, and so on.

A system implementation can include a search results component that receives a no-results indication of no results in response to a query for information using a search engine. The search results component can be an application or module of the search engine that currently exists to at least receive some signal or data that represents that no results are found (will be returned) for the query. If designed as a new component, the search results component can be code or a program that “listens” for (detects or receives) the no-results indication as is generated internally to the search engine, and once received, initiates topic selection, content sources access, and retrieval of content for presentation in combination with a no-results notice in a no-results page.

In a specific exemplary implementation, the topic and rich content relates to a benevolent act such as for orphaned children. The rich content can include a topic statement such as a plea for consideration for the benevolent topic, a picture of the orphan child, basic information that describes the orphan child including gender, approximate age, height, hair and eye color, etc. The rich content can also include a telephone number (or other contact information) for contacting the child or a child representative, and a social network sharing module that enables the rich content to be shared with other users and/or other media technologies (e.g., radio, TV, cell phones, etc.).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a more detailed system of topic and content selection related to different content sources.

FIG. 3 illustrates an exemplary user interface showing a no-results search page generated in accordance with the disclosed architecture.

FIG. 4 illustrates a user interface having multiple different types of search query entry points and that can end in the no-results page.

FIG. 5 illustrates a method in accordance with the disclosed architecture.

FIG. 6 illustrates an alternative method in accordance with the disclosed architecture.

FIG. 7 illustrates a block diagram of a computing system that executes no-result search page rich content generation in accordance with the disclosed architecture.

### DETAILED DESCRIPTION

The disclosed architecture inserts rich content in a no-results page returned from a search engine query. The rich content can be related to any topic (e.g., person, or any entity of interest) selected (e.g., randomly) for insertion in the no-results page. The topic and content (e.g., related) can be obtained from different sources, such as trending topics of social networks, non-profit organization websites, and so on. This most popular topic and content can also be relative to the most popular queries, as obtained from query logs. The rich no-results page experience not only conveys (presents) the no-results notice, but also serves as a channel to promote search engine assets and deliver social networking viral features to emotionally connect to users such as related to benevolent acts and humanitarian efforts, for example.

For example, in at least one country, there are large numbers of orphaned children that cannot find their parents, and are given little visibility in society even though there are many people wanting to help. One implementation of the disclosed architecture utilizes the no-results page in the search technology as a means of high visibility to Internet users, not only to communicate to the user the basic no-results message for no results found, but to also display rich content conveying, for example, that “there are many orphaned children who cannot find their parents either, would you please help these children find their parents?” In this example, the rich content can include a picture of the orphaned child, the basic information of the child such as gender, approximate age, height, weight, color of hair, eyes, etc., and contact information (e.g., a telephone number, email address, etc.) for reaching the child and/or a representative. A social network sharing module as part of the rich content enables the topic and content to be shared with others.

The topics and content can be obtained from sources (feeds) such as non-profit organizations, and ingested into the disclosed architecture for regular updating. When the no-result page is generated for presentation, the topic and related content can be randomly selected (or via other selection techniques such as sequentially) from a topic/content datastore and/or directly from the data feeds, and then displayed in the no-results page. This technique may instill in the user the feeling that the search engine and engine provider cares about society and uses its resources in a way that helps in a positive way.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

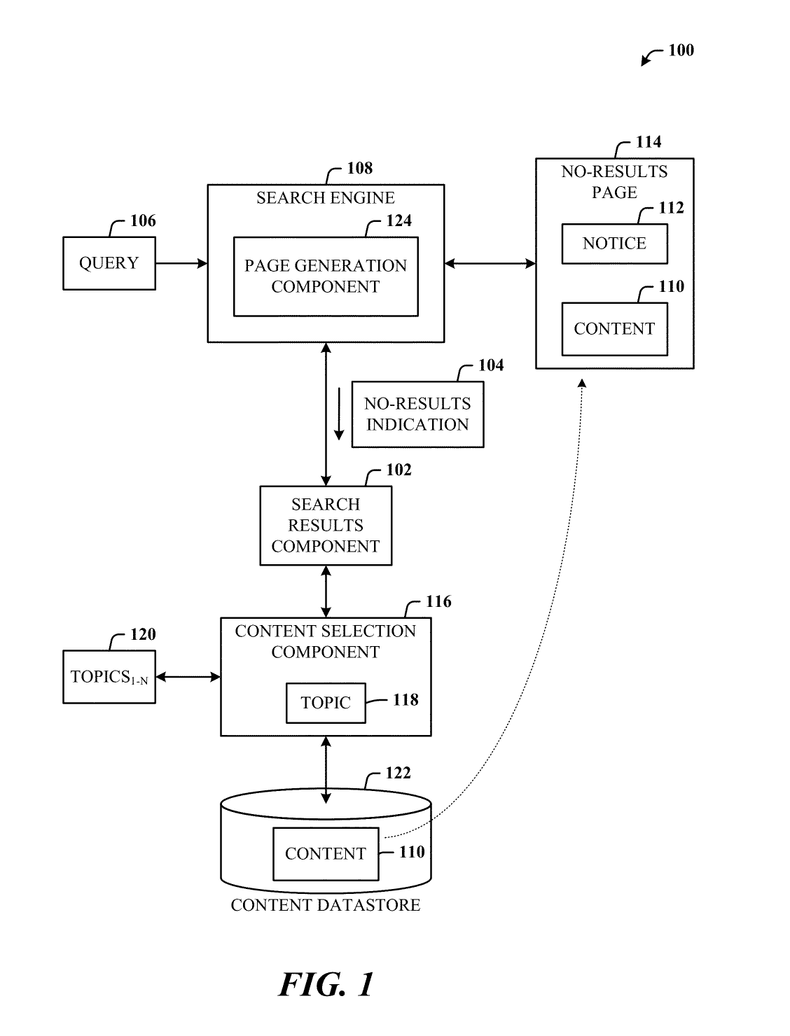

FIG. 1 illustrates a system 100 in accordance with the disclosed architecture. The system 100 can include a search results component 102 that receives a no-results indication 104 of no results in association with (e.g., in response to) a query 106 for information using a search engine 108. The search results component 102 can be an application or module that currently exists as part of the search engine 108 to at least receive some signal or data that represents that no results are found (will be returned) for the query 106. If designed as a new component, the search results component 102 can be code or a program (as part of or separate from the search engine 108) that “listens” for (detects or receives) the no-results indication 104 as is generated internally to the search engine 108, and once received, initiates topic selection, content source(s) access, and retrieval of content 110 for presentation in combination with a no-results notice 112 in a no-results page 114.

In any case, the no-results indication 104 is received, and in association with receiving the no-results indication 104, the search results component 102 communicates with a content selection component 116, which then selects a topic 118 out of multiple topics 120, and also accesses the content 110 associated with the topic 118 as stored in a content datastore 122. The content 110 is then passed (through the search results component 102 to the search engine 108 or directly to the search engine 108) to a page generation component 124 that presents the content 110 and the no-results notice 112 in the no-results search page 114 (also referred to as the no-results page 114) generated by the search engine 108.

While the search results component 102 and the content selection component 116 are illustrated external to the search engine 108, it is to be understood that alternatively, either one or both of these components can be implemented internally as part of the search engine 108.

The content selection component 116 selects the topic 118, as related to an act of benevolence, and accesses rich content associated with the topic 118 for presentation in the no-results search page 114 with the no-results notice 112. The act of benevolence can be anything that exemplifies kindness, generosity, and compassion, such as humanitarian actions.

A more specific benevolent act relates to assisting orphaned children and other persons. It is the case that worldwide, large numbers of children may be displaced, become parentless, and homeless due to war, disease, poverty, and the like, which can result in missing children, orphaned children, and so on. The Internet provides a mechanism by which to bring the plight of these children (or humans, in general) and other acts of benevolence to the attention of millions of online users (anyone who can be presented with the no-results page 114 via any suitable device) who then may be able to assist in some way.

The Internet comprises myriad websites and other sources of information and content via which these benevolent acts can be characterized and defined. Many of these sources comprise non-profit organizations that seek to provide support for a given humanitarian effort as well as other benevolent needs. In most cases relating to people, the content includes media associated with a person, such as an image of the person (e.g., photo, video clip), contact information (e.g., a phone number to call, email address, etc.), and descriptive information of the person (e.g., age, height, weight, hair color, eye color, gender, etc.). Accordingly, in this usage context, the content selection component 116 randomly selects the topic 118 and content 110 from one of multiple sets of content associated with non-profit organizations.

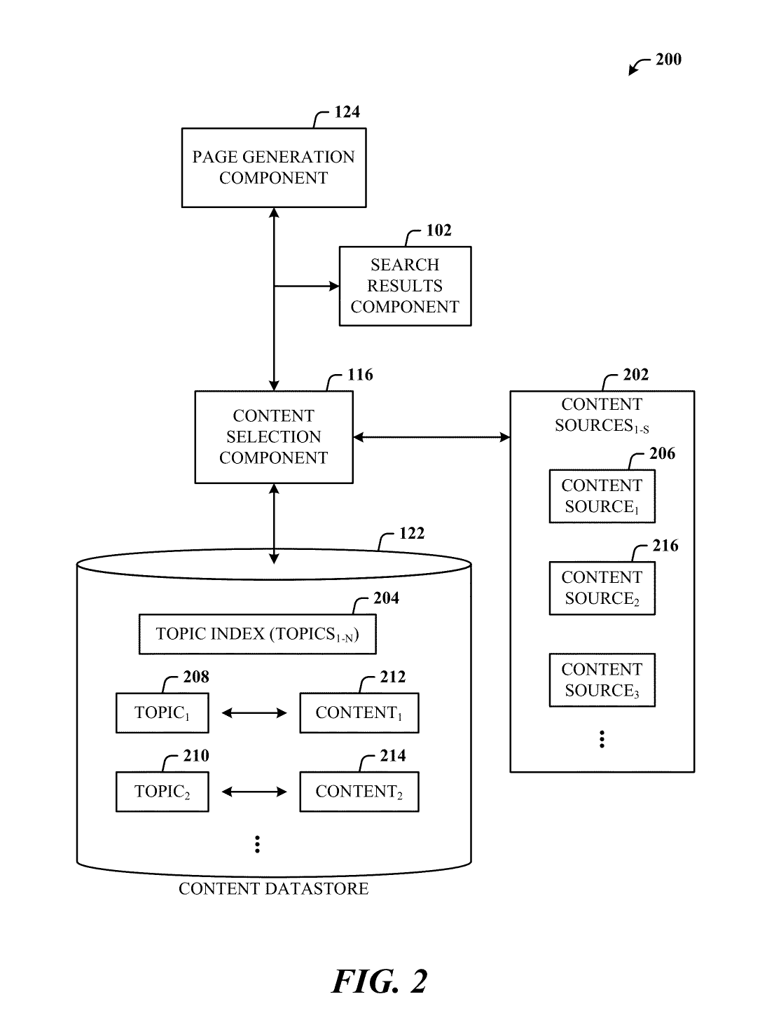

FIG. 2 illustrates a more detailed system 200 of topic and content selection related to different content sources 202. The content selection component 116 can access other content sources 202 and obtain topics (topic information) and associated topic content (e.g., rich) for storage in the content datastore 122. A topic index 204 can be created, updated, and maintained as new topics and content are obtained from the various content sources 202. Where the topics are related to benevolent acts, for example, the content sources 202 can include non-profit organization data sources such as websites, network groups of users who discuss and promote such acts, social network trend information as exposed for use, and so on.

More specifically, a first content source 206 can be a non-profit organization promoting a single benevolent act or multiples of such acts. The content selection component 116 can regularly access the first content source 206 for one or more topics, such as a first topic 208 and a second topic 210. The content selection component 116 also accesses and retrieves the associated (rich) content, such as first content 212 associated with the first topic 208 and second content 214 associated with the second topic 210.

Similarly, a second content source 216 can be a social network that exposes a trending topic related to a humanitarian effort. Accordingly, the content selection component 116 regularly accesses the second content source 216 for one or more topics, such as a third topic in the datastore 122 (not shown). The content selection component 116 can also access and retrieve the content from the social network (the second content source 216) associated with the third topic, such as third content of the content datastore 122 (also not shown).

When the no-results is indicated (by the indicator 104), the content selection component 116 automatically selects (e.g., randomly) the rich content, either directly from the data feeds (the content source(s) 202) and/or from the datastore 122, and sends the rich content for presentation in the no-results page 114.

It can be the case that optionally, the content selection component 116 selects from a source, or enables the insertion from the source, one or more advertisements related to the topic. For example, if the topic is about an orphaned child, the advertisement can be for or by an organization that provides orphan services such as finding parents, etc.

It can be the case that optionally, the content selection component 116 selects from a source, or enables the insertion from the source, a public service announcement (PSA) related to the topic, and for a given geographical area. For example, if the topic is a missing child alert, the rich content can be retrieved and inserted for each no-results page returned for users in a related geographical area. Such PSAs may age out quickly such as for weather alerts, etc., as the notice or alert may pass relatively quickly compared to other longer-term topics.

The topics and content may also be filtered according to user preferences. If the user preferences are known (accessible) and the user chooses to only receive no-results content related to a certain category of topics, this can be customized to the user. For example, the user may choose to only receive no-results topics and content about animals (e.g., pets, endangered species, etc.), rather than children. The user may also choose to restrict the type of content in the rich content. For example, for a visually impaired user, the user may choose to only receive audio content that plays in the no-results page 114, rather than images or videos.

These particular implementations/customizations can be utilized when users interact in different ways, such as via gestures, speech, hand poses, etc., rather than reading, where the user may have visual limitations. Similarly, the hearing impaired user may choose to only see visual content rather than audio content.

By providing this rich content capability, even though users may not receive the desired web documents for a query, they may feel more strongly that the search engine and engine provider is caring about society, causes, etc., and use this technology to assist in any way.

Accordingly, the content selection component 116 selects the topic as related to search engine assets and accesses rich content (content 110) associated with the search engine assets for presentation in the no-results search page 114 with the no-results notice 112. The content selection component 116 selects the topic 118 as related to a social network trending topic and accesses rich content (content 110) associated with the social network trending topic for presentation in the no-results search page 114 with the no-results notice 112 (e.g., textual only). The content selection component 116 frequently accesses content sources 202 and updates the content (stored in the datastore 122) from the content sources 202. Alternatively, the content sources 202 push their topics and related content to the content selection component 116. This can further include adding new topics and associated content, as well as aging out (deleting after a specified period of time) old topics and topic content.

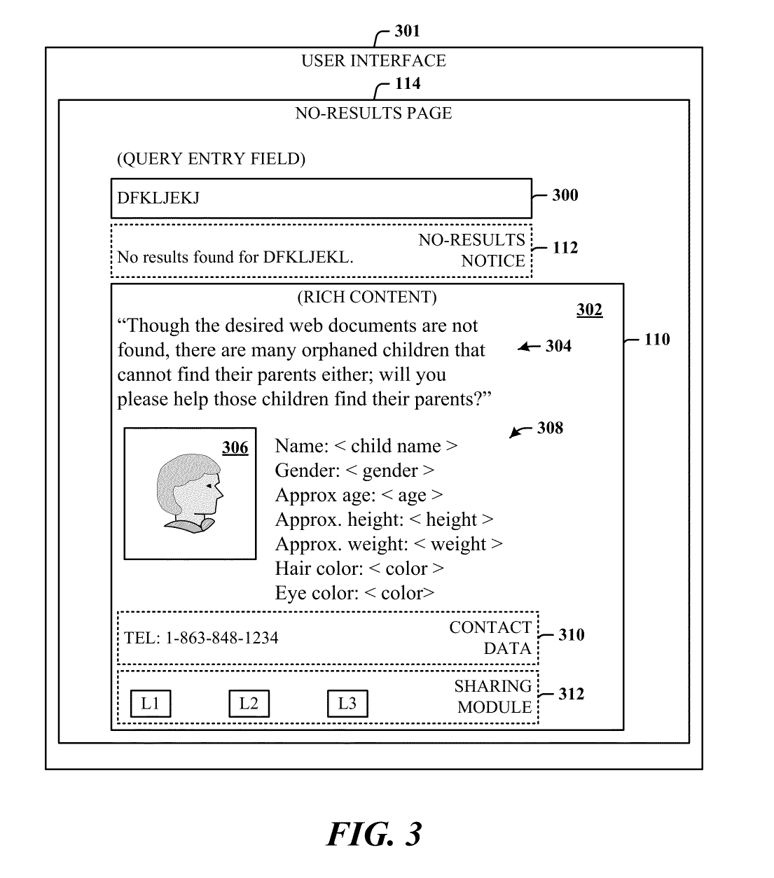

FIG. 3 illustrates an exemplary user interface 301 showing the no-results search page 114 generated in accordance with the disclosed architecture. In this example, the page 114 comprises a query entry field 300 in which a user enters a query for processing by a search engine. Here, the query is “DFKLJEKJ”, which returns the no-results notice 112—“No results found for DFKLJEKJ.”

Additionally, the no-results page 114 further comprises the content 110, for example rich content 302. The rich content 302 includes a topic statement 304 that identifies the topic 118 (of FIG. 1) to the viewer. Here, the topic 118 is orphaned children. Moreover, the topic statement 304 makes a plea to the viewer, as part of a benevolent act, to “help orphaned children . . . find their parents”. In support of the benevolent act, the rich content 302 further includes an image 306 of the orphaned child, as well as identifying description information 308 for the orphan. The information 308 can include a name, gender, approximate age, approximate height, approximate weight, hair color, eye color, and other information deemed suitable to aid the viewer in identifying the child.

The rich content 302 can also comprise contact data 310 such as a telephone number, email address, or any other type of contact information. The rich content 302 can also include a sharing module 312. The module 312 includes one or more links (Lx) to other networks, such as social networks. Here, a first link L1, when selected, navigates the user to a first social network, a second link L2, when selected, navigates the user to a second social network, and a third link L3, when selected, navigates the user to a third network. Any link selection will also facilitate communication of the rich content 110 to the desired destination on that network, or even to a specific destination, such as a target user. Thus, the system further comprises a sharing module 312 that enables the content to be sent to other destinations via the no-results search page 114.

It is to be understood that the illustrated rich content 302 is just one type of topic content that can be retrieved and presented as part of the no-results page generation. The topic 118 for the act of benevolence can be anything that exemplifies kindness, generosity, and compassion, such as humanitarian actions, and actions for the protection of animals and the earth, for example. A goal is not only to assist in these causes, but also to instill in the user that the search engine and associated search engine vendor care about society, any causes of its people, and use every opportunity available to assist in these causes.

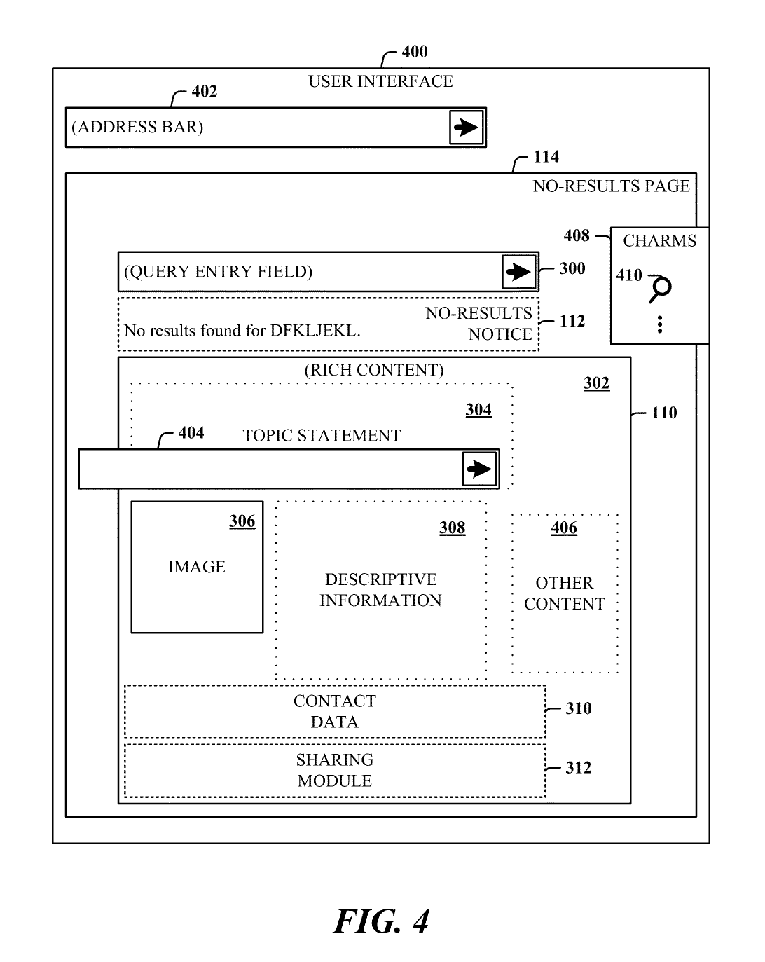

FIG. 4 illustrates a user interface 400 having multiple different types of search query entry points and that can end in the no-results page 114. In addition to a traditional search box (the query entry field 300), the user interface 400 includes an address bar 402 for query entry (and web address entry), and the processing of which can end in the no-results page 114, notice 112, and rich content 302. The rich content 302 can comprise any one or more of the topic statement 304, the image 306, descriptive information 308, contact data 310, sharing module 312, and other content 406 (e.g., animated graphics, auto-play features of audio and/or video, etc.).

Alternatively, or in combination therewith, the user interface 400 can include a plug-in (to the browser) that enables a movable query bar 404 for entry of the query, and the processing of which also then can end in the no-results page 114, notice 112, and rich content 302. The user interface 400 can also present a menu 408 of “charms” (UI elements) that appears (hides and unhides) on an edge of the user interface, and which one of the charms is a search control 410 for initiating a search process using a query—the processing of which can end in the no-results page 114, notice 112, and rich content 302.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

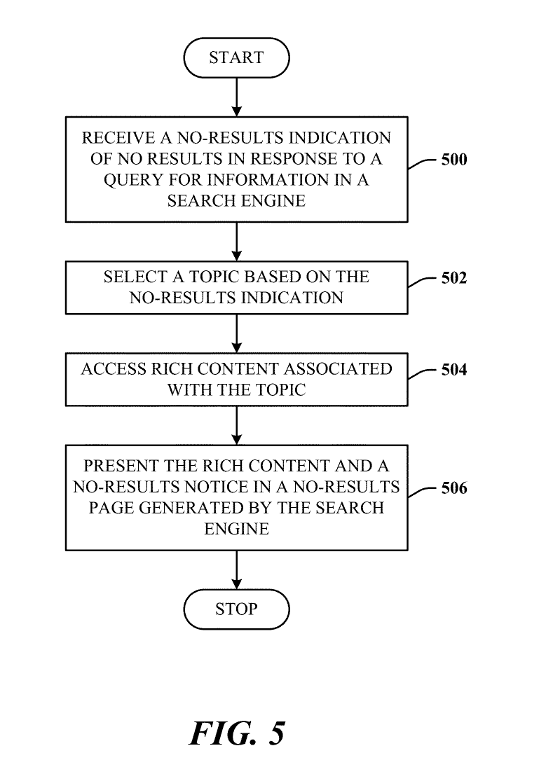

FIG. 5 illustrates a method in accordance with the disclosed architecture. At 500, a no-results indication of no results is received in response to a query for information in a search engine. The indication (e.g., signal) can be obtained from the search engine modules/components. At 502, a topic is selected based on the no-results indication. The topic can be selected from an index of topics in a datastore and/or obtained, as randomly determined, directly from the content sources (feeds).

At 504, rich content associated with the topic is accessed. The topic can be first selected and then the associated content. Alternatively, the source can be selected randomly, and then the topic and content obtained therefrom. At 506, the rich content and a no-results notice are presented in a no-results page generated by the search engine.

The method can further comprise selecting the topic as related to an act of benevolence and accessing rich content associated with the topic for presentation in the no-results page with the no-results notice. The method can further comprise selecting the topic as related to search engine assets and accessing rich content associated with the search engine assets (e.g., hardware and/or software resources and capabilities) for presentation in the no-results page with the no-results notice. The method can further comprise randomly selecting the topic as associated with non-profit organization data (e.g., topic and content) feeds.

The method can further comprise selecting the topic as related to a social network trending topic and accessing the rich content associated with the social network trending topic for presentation in the no-results page with the no-results notice. The trending topic (also referred as a “viral” topic) can appear randomly based on user activity and interaction, and disappear as well. Thus, by selecting the trending topic, the no-results page will present the most recent viral information.

The method can further comprise selecting the topic as related to a missing person and accessing the rich content associated with the missing person for presentation in the no-results page with the no-results notice.

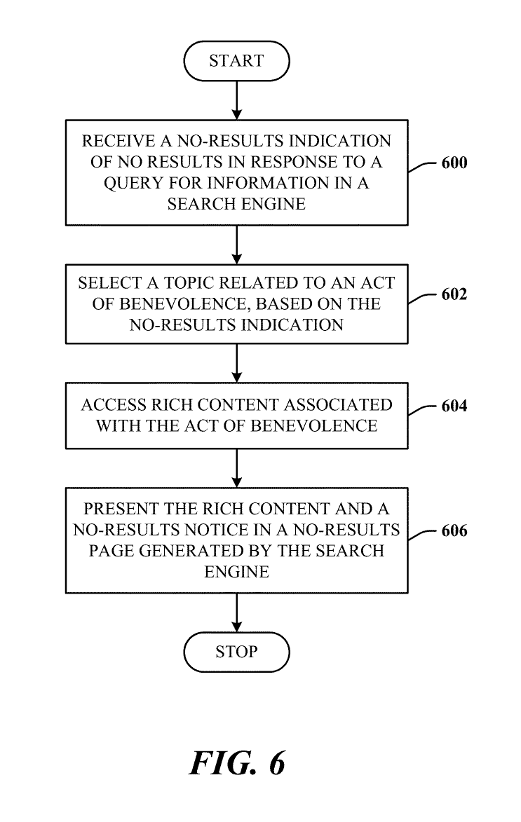

FIG. 6 illustrates an alternative method in accordance with the disclosed architecture. At 600, a no-results indication of no results is received in response to a query for information in a search engine. At 602, a topic related to an act of benevolence is selected, based on the no-results indication. At 604, rich content associated with the act of benevolence is accessed. At 606, the rich content and a no-results notice are presented in a no-results page generated by the search engine.

The method can further comprise randomly selecting the topic as associated with non-profit organization data feeds. The method can further comprise selecting the topic as trending in a social network and accessing rich content associated with the social network trending topic for presentation in the no-results page with the no-results notice. The method can further comprise selecting the topic as related to an orphaned person and accessing the rich content associated with the orphaned person for presentation in the no-results page with the no-results notice.

The method can further comprise sharing the rich content with other users and media entities via the no-results page. The method can further comprise frequently accessing content sources, updating existing topics and topic content, and obtaining new topics and new topic content from the content sources. This can be accomplished by the content sources pushing the topics and content to the disclosed architecture or responding only when requested to respond with the topics and content (polling by the architecture).

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

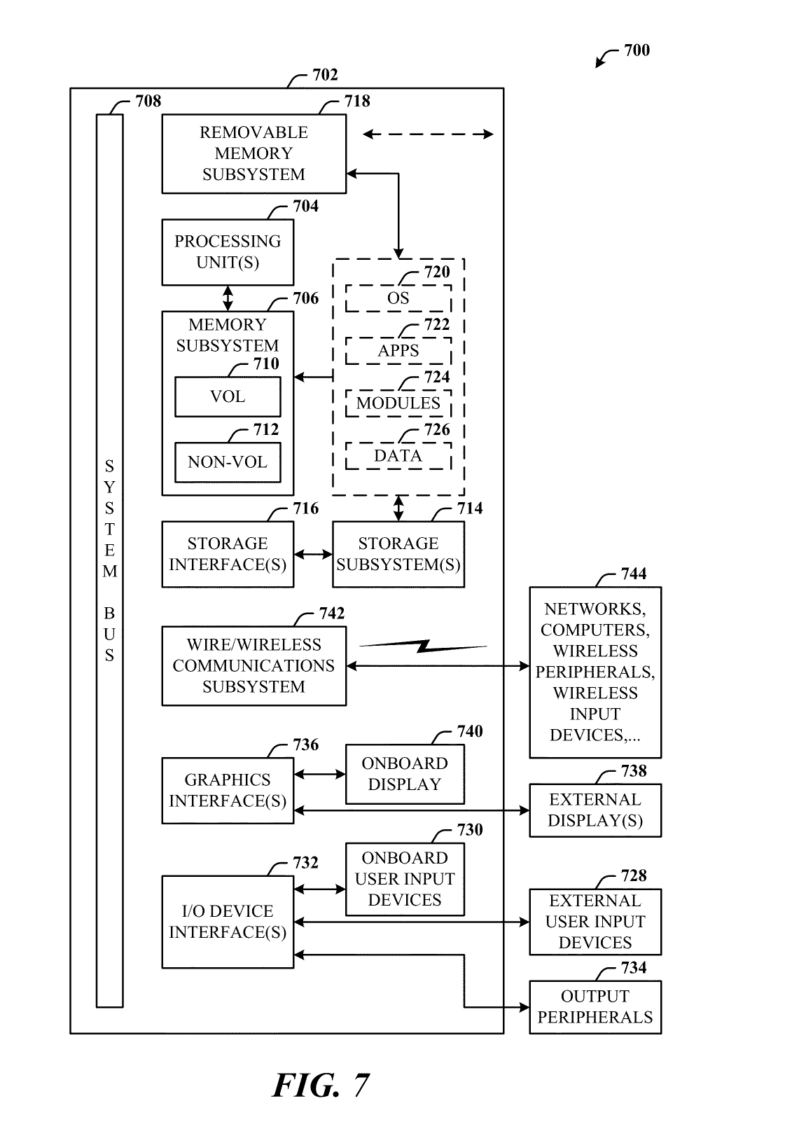

Referring now to FIG. 7, there is illustrated a block diagram of a computing system 700 that executes no-result search page rich content generation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704 (also referred to as microprocessor(s) and processor(s)), a computer-readable storage medium such as a system memory 706 (computer readable storage medium/media also include magnetic disks, optical disks, solid state drives, external memory systems, and flash memory drives), and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage) medium such as a volatile (VOL) memory 710 (e.g., random access memory (RAM)) and a non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the system 200 of FIG. 2, entities and components of the user interface 301 and no-results page 114 of FIG. 3, entities and user interface 400 of FIG. 4, and the methods represented by the flowcharts of FIGS. 5 and 6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 702, and include volatile and non-volatile internal and/or external media that is removable and/or non-removable. For the computer 702, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example.

These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11× (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a search results component that receives a no-results indication of no results in response to a query for information using a search engine;
a content selection component that selects a topic based on the no-results indication and accesses content associated with the topic; and
a page generation component that presents the content and a no-results notice in a no-results search page generated by the search engine.

2. The system of claim 1, wherein the content selection component selects the topic as related to an act of benevolence and accesses rich content associated with the topic for presentation in the no-results search page with the no-results notice.

3. The system of claim 1, wherein the content selection component selects the topic as related to search engine assets and accesses rich content associated with the search engine assets for presentation in the no-results search page with the no-results notice.

4. The system of claim 1, wherein the content selection component selects the topic as related to a social network trending topic and accesses rich content associated with the social network trending topic for presentation in the no-results search page with the no-results notice.

5. The system of claim 1, wherein the content selection component randomly selects the topic and content from one of multiple sets of content associated with non-profit organizations.

6. The system of claim 1, wherein the content selection component frequently accesses content sources and updates the content from the content sources.

7. The system of claim 1, further comprising a sharing module that enables the content to be sent to other destinations via the no-results search page.

8. The system of claim 1, wherein the content includes media associated with a person, the media includes an image of the person, contact information, and descriptive information of the person.

9. A method performed by a computer system executing machine-readable instructions, the method comprising acts of:
receiving a no-results indication of no results in response to a query for information in a search engine;
selecting a topic based on the no-results indication;
accessing rich content associated with the topic; and
presenting the rich content and a no-results notice in a no-results page generated by the search engine.

10. The method of claim 9, further comprising selecting the topic as related to an act of benevolence and accessing rich content associated with the topic for presentation in the no-results page with the no-results notice.

11. The method of claim 9, further comprising selecting the topic as related to search engine assets and accessing rich content associated with the search engine assets for presentation in the no-results page with the no-results notice.

12. The method of claim 9, further comprising randomly selecting the topic as associated with non-profit organization data feeds.

13. The method of claim 9, further comprising selecting the topic as related to a social network trending topic and accessing the rich content associated with the social network trending topic for presentation in the no-results page with the no-results notice.

14. The method of claim 9, further comprising selecting the topic as related to a missing person and accessing the rich content associated with the missing person for presentation in the no-results page with the no-results notice.

15. A computer-readable medium comprising computer-executable instructions that when executed by a processor, cause the processor to perform acts of:
receiving a no-results indication of no results in response to a query for information in a search engine;
selecting a topic related to an act of benevolence, based on the no-results indication;
accessing rich content associated with the act of benevolence; and
presenting the rich content and a no-results notice in a no-results page generated by the search engine.

16. The computer-readable medium of claim 15, further comprising randomly selecting the topic as associated with non-profit organization data feeds.

17. The computer-readable medium of claim 15, further comprising selecting the topic as trending in a social network and accessing rich content associated with the social network trending topic for presentation in the no-results page with the no-results notice.

18. The computer-readable medium of claim 15, further comprising selecting the topic as related to an orphaned person and accessing the rich content associated with the orphaned person for presentation in the no-results page with the no-results notice.

19. The computer-readable medium of claim 15, further comprising sharing the rich content with other users and media entities via the no-results page.

20. The computer-readable medium of claim 15, further comprising frequently accessing content sources, updating existing topics and topic content, and obtaining new topics and new topic content from the content sources.
